(19) United States
(12) Patent Application Publication
(10) Pub. No.: US 2013/0147222 A1
(43) Pub. Date: Jun. 13, 2013

(54) STORAGE COMPARTMENT IN THE PILLAR OF A VEHICLE

(71) Applicants: Paresh Rana, Clawson, MI (US); George A. Konstantakopoulos, Birmingham, MI (US); Brett Ladetto, Clarkston, MI (US)

(72) Inventors: Paresh Rana, Clawson, MI (US); George A. Konstantakopoulos, Birmingham, MI (US); Brett Ladetto, Clarkston, MI (US)

(21) Appl. No.: 13/671,678

(22) Filed: Nov. 8, 2012

Related U.S. Application Data
(60) Provisional application No. 61/570,084, filed on Dec. 13, 2011.

(51) Int. Cl. B60R 11/02

(52) U.S. Cl. CPC B60R 11/0217
USPC 296/37.1

(57) ABSTRACT

A storage compartment integrated into a pillar of a vehicle that may be enclosed by a movable door accessible from an exterior of the vehicle. The door may support at least one audio speaker such that if the door is closed, the audio speaker may act as an interior audio speaker, and if the door is opened, the audio speaker may act as an exterior audio speaker.

### CROSS-REFERENCE TO RELATED APPLICATION

This application claims the benefit of U.S. Provisional Ser. No. 61/570,084, filed Dec. 13, 2011.

### FIELD

The present disclosure relates to a storage compartment integrated into a pillar of a vehicle, and to a dual-purpose compartment integrated into a pillar of the vehicle.

### BACKGROUND

Customers of motor vehicles are beginning to demand more functionality from their vehicles. In this regard, customers may require vehicles that may be used for travel to and from everyday activities such as work, buying groceries, and transporting their children, as well as be used for activities such as enjoying the outdoors. As the uses of these vehicles increase, additional storage and functionality is required to support the multiple activities for which these vehicles are used.

### SUMMARY

The present disclosure provides a storage compartment integrated into a pillar of a vehicle that may be enclosed by a movable door accessible from an exterior of the vehicle. The door may support at least one audio speaker such that if the door is closed, the audio speaker may act as an interior audio speaker, and if the door is opened, the audio speaker may act as an exterior audio speaker.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### DRAWINGS

FIG. 1 is a partial perspective view of a vehicle including a storage compartment that is integrated into a pillar of the vehicle in accordance with a principle of the present disclosure;

FIG. 2 is a partial perspective view of the storage compartment illustrated in FIG. 1 in an open configuration according to a principle of the present disclosure;

FIG. 3 is another view of the storage compartment illustrated in FIG. 1; and

FIG. 4 is a partial perspective view of an interior of the vehicle illustrated in FIG. 1.

### DETAILED DESCRIPTION

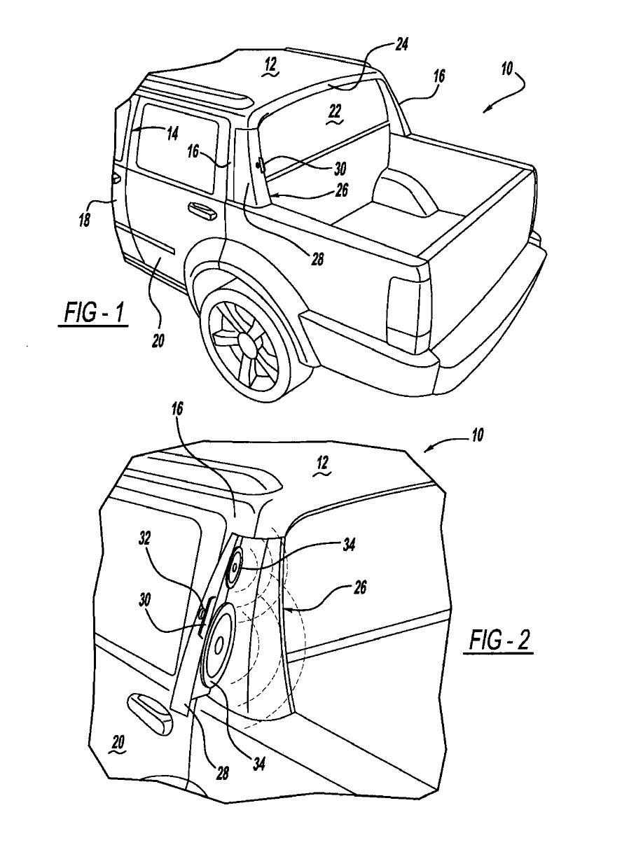

FIG. 1 illustrates a vehicle 10. Vehicle 10 includes a roof 12 that is supported by an A-pillar 11 (FIG. 4), a B-pillar 14, and a C-pillar 16, as is known in the art. Although not shown in the drawings, one skilled in the art will recognize and appreciate that the A-pillars are located on opposing sides of the vehicle's windshield (not shown), the B-pillars 14 provide support to roof 12 between passenger doors 18 and 20, and the C-pillars 16 are located on opposing sides of rear window 22 of vehicle 10, and are used to support roof 12 at a rear portion 24 thereof. In an exemplary embodiment, the storage compartment may be accessible from an exterior region of the vehicle. In another embodiment, the storage compartment may be accessible from an interior region of the vehicle, and the storage compartment may or may not be covered at the interior access portion.

In the exemplary illustrated embodiment, vehicle 10 includes a C-pillar 16 that also includes a storage compartment 26 (FIG. 2) integrated therewith. Storage compartment 26, in a closed position, is enclosed by a door 28 that aesthetically corresponds to a shape of C-pillar 16. To open storage compartment 26, door 28 is provided with a handle 30. Door 28 may also be provided with a locking device 32 to secure any items (not shown) that may be stowed within storage compartment 26.

Although vehicle 10 in the exemplary illustrated embodiment is provided with storage compartment 26 integrated with C-pillar 16, the present disclosure should not be limited thereto. That is, one skilled in the art will acknowledge and appreciate that various vehicles may not include a C-pillar 16. In contrast, some vehicles may include only an A-pillar (e.g., a convertible vehicle), or may include only an A-pillar and a B-pillar (e.g., a coupe or single-row pickup truck). Regardless, it should be understood that any of A-pillar 11, B-pillar 14, and C-pillar 16 may be modified to include storage compartment 26.

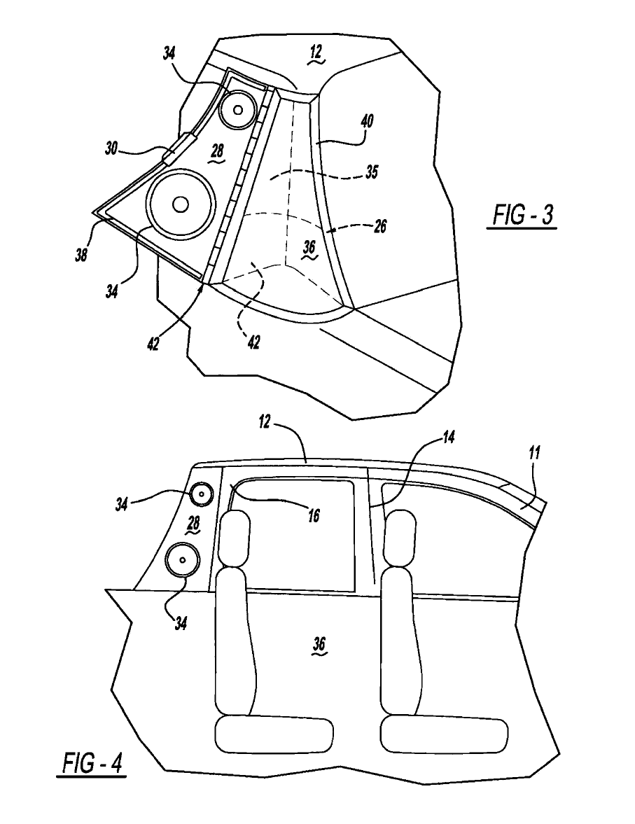

To further increase functionality of storage compartment 26, referring to FIGS. 2-4, door 28 may support at least one audio speaker 34 therein. When door 28 is in a closed position, audio speaker 34 may face an interior 36 of vehicle to serve as an interior audio speaker. When door 28 is an open position (FIGS. 2 and 3), audio speakers 34 may function as exterior audio speakers. Such a configuration increases the functionality of vehicle 10, as well as increases the functionality of audio speakers 34. Regardless whether door 28 is opened or closed, storage compartment 26 may be accessed from either interior 36 or exterior of vehicle 10.

Although audio speakers 34 are described above as being supported by door 28, it should be understood that speakers 34 may be supported by a wall 35 of storage compartment 26 without departing from the scope of the present disclosure. Regardless whether speakers 34 are supported by door 28 or by wall 35, speakers 34 may function as both interior audio speakers if storage compartment 26 is closed and exterior audio speakers if storage compartment 26 is open to the exterior of vehicle 10.

As illustrated in FIG. 3, to ensure that storage compartment 26 remains weather-proof in a closed position, door 28 includes a weather seal 38 around a perimeter thereof. Seal 38 may be any type of seal known to one skilled in the art. For example, seal 38 may be an ethylene propylene diene monomer (EPDM) seal, a styrene butadiene monomer (SBM) seal, or the like. Regardless, when door 28 is closed, seal 38 may engage flange 40 that surrounds storage compartment 26 to ensure no moisture may enter storage compartment when door 28 is closed. In addition, if storage compartment 26 is accessible from each of an interior 36 and an exterior of the vehicle, storage compartment 26 may be provided with a half-wall 42 having a height less than a height of C-pillar 16 to prevent items that may be stowed within storage compartment 26 from falling into interior 36 of vehicle 10 during operation thereof.

As shown in FIG. 3, door 28 is pivotably connected to storage compartment 26 by a hinge 42. Hinge 42 may be any type of hinge known to one skilled in the art. As illustrated in FIG. 3, hinge 42 may be a piano-style hinge. Alternatively, hinge 42 may be spring-loaded to bias door 28 to a closed position. Such a configuration may be desirable if storage compartment 26 does not include audio speakers 34 that are supported by door 28. Other connection mechanisms may also be used to couple door 28 to storage compartment 26, without limitation, as desired by one skilled in the art.

What is claimed is:

1. A storage compartment integrated into a pillar of the vehicle.

2. The vehicle of claim 1, wherein said storage compartment houses at least one audio speaker.

3. The vehicle of claim 2, wherein if said storage compartment is closed, said speaker acts as an interior speaker and if said storage compartment is opened, said speaker acts as an exterior speaker.

4. The vehicle of claim 1, wherein said storage compartment is enclosed by a movable door accessible from an exterior of the vehicle.

5. The vehicle of claim 4, wherein said door supports at least one audio speaker.

6. The vehicle of claim 5, wherein if said door is closed, said audio speaker acts as an interior audio speaker, and if said door is opened, said audio speaker acts as an exterior audio speaker.

7. The vehicle of claim 4, wherein said door includes a locking device.

8. The vehicle of claim 1, wherein said storage compartment is accessible from an interior of the vehicle.

9. A vehicle, comprising:
a roof supported by at least a pair of pillars;
an interior;
an exterior; and
a storage compartment integrated into at least one of said pillars,
wherein said storage compartment is accessible form each of said interior and said exterior of the vehicle.

10. The vehicle of claim 9, wherein said storage compartment houses at least one audio speaker.

11. The vehicle of claim 10, wherein if said storage compartment is closed, said speaker acts as an interior speaker and if said storage compartment is opened, said speaker acts as an exterior speaker.

12. The vehicle of claim 9, wherein said storage compartment is enclosed by a movable door accessible from the exterior of the vehicle.

13. The vehicle of claim 12, wherein said door supports at least one audio speaker.

14. The vehicle of claim 13, wherein if said door is closed, said audio speaker acts as an interior audio speaker, and if said door is opened, said audio speaker acts as an exterior audio speaker.

15. The vehicle of claim 12, wherein said door includes a locking device.
